(19) United States
(12) Patent Application Publication
(10) Pub. No.: US 2005/0112534 A1
(43) Pub. Date: May 26, 2005

(54) Methods for the treatment of autistic spectrum disorders

(76) Inventors: Cecelia McCarton, Stanford, CT (US); Ivy Feldman, New York, NY (US); Jacquelin Hickey, New York, NY (US)

Correspondence Address: MORRISON & FOERSTER LLP, 3811 VALLEY CENTRE DRIVE, SUITE 500, SAN DIEGO, CA, 92130-2332, US

(21) Appl. No.: 10/949,834

(22) Filed: Sep. 23, 2004

Related U.S. Application Data
(60) Provisional application No. 60/505,499, filed on Sep. 23, 2003.

(51) Int. Cl. G09B 19/00

(52) U.S. Cl. 434/236; 434/185

(57) ABSTRACT

The present invention relates to educational and therapeutic methods for treating subjects afflicted with an autistic spectrum disorder (ASD).

### CROSS-REFERENCE TO RELATED APPLICATION

The present application claims the benefit of priority under 35 U.S.C. § 119(e) of provisional application Ser. No. 60/505,499, filed Sep. 23, 2003.

### TECHNICAL FIELD

The present invention relates to methods for treating an autistic spectrum disorder (ASD).

### BACKGROUND OF THE INVENTION

Autism is a crippling neurological disorder. Children with an ASD have severe communication and language delays, sensory processing abnormalities, difficulty acquiring self-help skills, and experience delayed social interaction. Autism is a developmental disorder affecting critical aspects of a child's interaction with the external world. Defining characteristics include a significant impairment in social skills, a significant impairment in the ability to use words to communicate and lack of appropriate cognitive and behavioral flexibility, often manifested as perseverative behavior or poor impulse control. There is no typical autistic child. Autism is known as a spectrum disorder because there is a wide range of characteristics and degrees of severity. However, all children with autistic spectrum disorder have common deficits in social and language skills seen from early childhood and restricted patterns of behavior.

ASD has reached epidemic proportions, not only in the United Stated but in many countries throughout the world (England, Japan and the Scandinavian countries). The Center for Disease Control (CDC) has documented that ASD occurs in 1 in 500 children. Moreover, the syndrome is found in more males than females, at a ratio of about 4 to 1. In the last ten years there has been an alarming increase in the number of children diagnosed with autism. The U.S. Department of Education Report to Congress in 1999 indicated a ten year growth rate of 172% in the United States. A California study described an increase of 273% in autism diagnoses in California between 1990 and 1999 (Calif. Dept. of Devel. Svcs. Report 1999). In some areas such as Brick Township in New Jersey, the estimated rate of occurrence is 1 in 150 children. The number of children affected with ASD now exceeds the numbers of children with childhood cancer, leukemia, spina bifida, and Down's syndrome. The reason for this exponential rise in ASD is unknown. Moreover, the Autism Society of America (ASA) estimates that the overall cost of Autism on the U.S. economy is currently $90 Billion, and estimates that the annual cost in 10 years will be between $200-$400 Billion.

Unfortunately, most families have enormous difficulty accessing necessary services. Because of the dramatic increase in autism, there is a shortage of specialists. For example, the New York State funded early intervention program for children with special needs cannot provide treatment at the intensity that most autistic children need to make real progress. Many parents are left with no other option than to quit their jobs in order to care for their autistic child and coordinate a full-time home-based early intervention behavioral program, at great strain and sacrifice to the entire family.

While research into the causes of autism is ongoing, there is currently no cure. The best and only hope for autistic children right now is early intervention. Although a variety of different types of therapies are currently advocated, ranging from diet alteration to drug therapy, these are not considered consistently effective treatments. However, since the advent of early, aggressive, comprehensive intervention for children with ASD, recovery rates have improved dramatically. Often, appropriately treated children may be able to enter mainstream schools where they are indistinguishable from their peers. According to the New Jersey Center for Outreach and Services for the Autism Community (COSAC), “with appropriate intervention, many of the associated behaviors can be positively changed, even to the point that the child may appear . . . to no longer have autism.” Intensive therapy addressing an autistic child's deficits can have a dramatic, positive impact on his or her long-term prognosis. In some cases, this type of approach has reversed the onset of autistic symptoms.

Prior to 1990, the acceptable treatment for ASD consisted of placing the child in special education and sporadically offering supplemental therapies. The rates of recovery were less than 1% during this time. Two of the current types of therapy practiced for children with ASD are ABA therapy (developed by Dr. Lovaas) and Floor Time (developed by Dr. Greenspan).

ABA is an empirically-based method that utilizes behavioral techniques to teach skills to children in an individualized setting. Skills that are to be acquired are broken down into small increments and taught in a highly structured format to maximize feelings of success. A high amount of reinforcement is utilized to increase skills and decrease maladaptive behaviors. While proponents are obviously in favor of this approach, many opponents assert that poor science forms the basis of this type of therapy and believe that the children who received this therapy become robotic and mechanical.

Floor Time is a relationship-based developmental approach that also utilizes 1:1 experience to facilitate the child's emotional and cognitive growth. With this method, the adult follows the child's lead in a play session to encourage interaction, improve self-regulation and enhance problem-solving skills.

Traditional methods of treatment have typically championed a single modality for all children (e.g., ABA therapy or Floor Time), with variable success. ABA is instructor driven, while floor time is child driven (i.e., the therapist mirrors what the child is doing). Historically, ABA programs concentrated on sitting the child in a chair to gain instructional control and, unfortunately, it has become overly focused on academic skills, teaching in a rigid fashion and ignoring the importance of play. The floor time model follows the child's lead, mirroring their actions. Unfortunately, most ASD children do not know how to interact appropriately with objects, animals and people, and following their lead does not teach them how to interact appropriately. Thus, traditional methods of treatment have limited success in treating ASD.

### SUMMARY OF THE INVENTION

The present invention provides methods for treating autistic spectrum disorders. More particularly, the present invention provides an integrated approach for treating or ameliorating an autistic spectrum disorder.

In one embodiment, the present invention provides methods for ameliorating an autistic spectrum disorder (ASD), comprising:
a) subjecting a person diagnosed with an autistic spectrum disorder (ASD) to a primary interaction comprising an applied behavior analysis (ABA) exercise with an instructor in a one-to-one setting;
b) subjecting the person to a secondary interaction with a group comprising an additional person diagnosed with an ASD, and an additional instructor one of which is a speech therapist; and
c) subjecting the person to occupational therapy.

Examples of ASD include but are not limited to an autistic disorder, Asperger's Syndrome, pervasive development disorder-Not Otherwise Specified (PDD-NOS), Rett's Disorder, Childhood Disintegrative Disorder (CDD), or a combination thereof.

Examples of ASD symptoms include but are not limited to symptoms having the characteristics set forth in the Diagnostic and Statistical Manual of Mental Disorders—Fourth Edition (DSM-IV). For example, such symptoms may comprise behavioral control, attention, cognitive skills, imitation of motor activities, sensory integration training, visual spatial skills, speech and language training comprising acquisition of expressive and receptive language skills, playing, following classroom routines, dressing, eating, improving oral motor skills, self-regulation, gross and/or fine motor skills training, or a combination thereof.

In particular embodiments, such symptoms may comprise those that have been baselined, and/or those that are capable of measurement by objective diagnostic measures. Examples of such objective diagnostic measures include but are not limited to the Autism Diagnostic Observation Schedule, the Bayley Scales of Infant Development, the Stanford-Binet Intelligence Scale, the Wechsler Preschool and Primary Scale of Intelligence, the Preschool Language Scale, the Receptive and Expressive One Word Vocabulary Tests, the Peabody Developmental Motor Scales for Gross and fine motor performance, the Assessment of Basic Language and Learning Skills, and/or a combination thereof, among others known in the art.

In the above methods, the primary interaction may comprise an ABA exercise capable of improving deficiencies in communication, behavior, gross motor skills and sensory integration. In particular, the ABA exercise may be a ground exercise. For example, the primary interaction may comprise an ABA grounded exercise comprising behavioral control, attention, cognitive skills, imitation of motor activities, sensory integration training, visual spatial skills, speech and language training comprising acquisition of expressive and receptive language skills, playing, following classroom routines, dressing, eating, improving oral motor skills, self-regulation, gross and/or fine motor skills training, or a combination thereof. More particularly, the ABA grounded exercise is focused on improving an ASD symptom in a subject. For example, the primary interaction may be directed to developing or improving motor systems, speech and language acquisition, communication skills, social skills, focus and attention, and cognitive skills, or a combination thereof.

In the above methods, the secondary interaction may comprise generalizing the ABA exercise with the group. In particular, the secondary interaction may comprise a supervised group interaction therapy.

In the above methods, a baseline level of functioning in an ASD symptom may be generated for the subject, based on the determination of strengths and weaknesses of the ASD symptom. Improvement in an ASD symptom may often be measured from the baseline level.

In the above methods, the subject may be placed in a peer group based on the determination of the strengths and weaknesses of an ASD symptom. The strengths and weaknesses may be determined using objective diagnostic measures and/or manuals such as the DSM-IV, previously described above. Each member of the peer group may also have a comparable level of functioning in an ASD symptom. Furthermore, an individualized education plan directed to improving the subject's baseline level of functioning in an ASD symptom may also be prepared prior to placing the subject with the peer group and/or in the classroom setting.

In the above methods, the group may comprise four persons diagnosed with an ASD, and four instructors, one of which is a speech therapist. In particular embodiments, the group comprises four or more persons diagnosed with an ASD, three instructors trained in ABA, and one speech therapist. Furthermore, the instructors in the group may work an occupational therapist to develop programs that will be used in the primary and secondary interactions.

In the above methods, the primary and secondary interaction may have a duration of about one hour and 15 minutes, respectively. The methods may further comprise a transition period between the primary and secondary interaction. The transition period may have a duration of about five seconds to about 5 minutes. Furthermore, the primary and secondary interaction may be repeated sequentially about 2 to 5 times, within a span of about 5 to 8 hours.

The present methods may further comprise an evaluation period, comprising the evaluation and documentation of the subject's expressive and receptive language, motor, imitation, planning, and/or pre-academic skills. In addition, based on the subject's relative strengths and weaknesses, a program may be created with goals outlined on a daily basis.

In a further embodiment, the subject's improvement from the baseline level of functioning is monitored each day. In one aspect, data is generated and catalogued to monitor the subject's improvement, utilizing objective diagnostic criteria. In another aspect, the data is entered into a computerized database to monitor the student's improvement over time. The individual therapy program may be re-evaluated on a periodic basis.

In another embodiment, therapy in accordance with the present methods is continued outside of the classroom setting, comprising further practice outside of the classroom of the exercises practiced during the primary and secondary interactions.

Furthermore, the present methods may be practiced in combination with other therapies. For example, the above methods may be practiced in combination with occupational therapy, speech therapy, music therapy, or a combination thereof.

### DETAILED DESCRIPTION OF THE INVENTION

For clarity of disclosure, and not by way of limitation, the detailed description of the invention is divided into the subsections that follow.

A. Definitions

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein, “treatment” refers to any manner in which the symptoms of a condition, disorder or disease are ameliorated or otherwise beneficially altered.

As used herein, “disease or disorder” refers to a pathological condition in an organism resulting from, e.g., infection or genetic defect, and characterized by identifiable symptoms.

As used herein, “occupational therapy” (OT) refers to a therapy provided by a person trained in the occupational therapy arts that assists in the individual's development of fine and gross motor skills that aid in daily living. It also can focus on sensory issues, coordination of movement, balance, and on self-help skills such as dressing, eating with a fork and spoon, grooming, etc. Further, this type of therapy can also address issues pertaining to visual perception and hand-eye coordination.

As used herein, “autistic spectrum disorder” or “ASD” refers to autism and similar disorders. Examples of ASD include disorders listed in the DSM-IV, namely Autistic Disorder, Asperger's Disorder, Pervasive Developmental Disorder—Not Otherwise Specified, Childhood Disintegrative Disorder, and Rett's Disorder.

As used herein, “sensory integration” (SI) refers to the way the brain processes sensory stimulation or sensation from the body and then translates that information into specific, planned, coordinated motor activity.

As used herein, the terms “generalizing” or “generalization” refer to the phenomenon of a subject responding to all situations similar to one in which it has been conditioned. Generalization often refers to the ability to elicit a response in a subject via similar stimuli which was specifically utilized to elicit the response on a one on one format. The process of generalization may encompass the concept that a particular stimulus is effective in eliciting similar responses after a subject learns to respond in a particular manner to a stimulus.

As used herein, “therapist” is used interchangeably with the term “instructor” and, on occasion the term “teacher.” Generally, therapists, teachers and/or instructors herein have undergone specific training in one or more therapeutic methods and realms discussed herein. Moreover, speech therapists are occasionally encompassed by the terms “instructors” or “therapists,” unless otherwise specified.

As used herein, the term “an ASD symptom” encompasses one or more ASD symptoms, and aspects and characteristics of ASDs or PDDs, as set out in a publication by the American Psychiatry Association that defines characteristics of such disorders. (See, e.g., DSM-IV (4th ed.)). Moreover, “an ASD symptom” may further encompass one or more skills or characteristics typically exhibited by a subject afflicted with an ASD as provided herein.

As used herein, “peer” refers to a subject diagnosed with an ASD, and “peer group” refers to two or more subjects diagnosed with an ASD. In particular embodiments, a peer group may comprise about 4 subjects. Further, a peer group may generally be organized based on one or more symptoms of an ASD, wherein each member of the peer group has a similar symptomology in one or more of the symptoms of an ASD based on an evaluation of each individual subject.

As used herein, “objective diagnostic criteria” refers to criteria capable of evaluation via the Autism Diagnostic Observation Schedule, the Bayley Scales of Infant Development, the Stanford-Binet Intelligence Scale, the Wechsler Preschool and Primary Scale of Intelligence, the Preschool Language Scale, the Receptive and Expressive One Word Vocabulary Tests, the Peabody Developmental Motor Scales for Gross and fine motor performance, the Assessment of Basic Language and Learning Skills, and/or a combination thereof. Other criteria capable of being measured and/or evaluated by other diagnostic tools or measures known and accepted in the art are also contemplated.

As used herein, “subject” refers to a person, child, student and/or patient diagnosed as afflicted with, or believed to be afflicted with an ASD. In general, a subject is, will, or has been subjected to the methods described herein.

B. Autistic Spectrum Disorders

The present methods may be used to ameliorate an autistic spectrum disorder symptom. The present methods may also be used to treat an autistic spectrum disorder. Examples of autistic spectrum disorders (or Pervasive Developmental Disorders (PDD)) described in The Diagnostic and Statistical Manual of Mental Disorders—Fourth Edition (DSM-IV), include autistic disorder, Asperger's Syndrome, PDD-Not Otherwise Specified (PDD-NOS), Rett's Disorder, and Childhood Disintegrative Disorder (CDD).

One or more additional disorders recognized in the art as further encompassed by the realm of autistic spectrum disorders are also contemplated in the present methods. Examples of additional disorders include Semantic Pragmatic Communication Disorder (e.g., characterized by delay and trouble with the use of semantic and pragmatic language, but not fully affecting socialization), non-verbal learning disabilities (e.g., characterized by trouble integrating information in verbal, spatial perception and motor coordination), high functioning autism (e.g., characterized by milder autism symptomology), hyperlexia (e.g., characterized by advanced and early reading skills), in addition to some aspects of Attention Deficit Hyperactivity Disorder (ADHD), such as impulse and control difficulties. Examples of ASD characteristics recognized in the DSM-IV, as provided by the American Psychiatry Association, are as follows.

1. Autistic Disorder

An autistic disorder may be characterized by a total of six (or more) items from (1), (2), and (3), with at least two from (1), and one each from (2) and (3):
1. qualitative impairment in social interaction, as manifested by at least two of the following: (a) marked impairment in the use of multiple nonverbal behaviors such as eye-to-eye gaze, facial expression, body postures, and gestures to regulate social interaction; (b) failure to develop peer relationships appropriate to developmental level; (c) a lack of spontaneous seeking to share enjoyment, interests, or achievements with other people (e.g., by a lack of showing, bringing, or pointing out objects of interest); or (d) lack of social or emotional reciprocity;
2. qualitative impairments in communication as manifested by at least one of the following: (a) delay in, or total lack of, the development of spoken language (not accompanied by an attempt to compensate through alternative modes of communication such as gestures or mime); (b) in individuals with adequate speech, marked impairment in the ability to initiate or sustain a conversation with others; (c) stereotyped and repetitive use of language or idiosyncratic language; or (d) lack of varied, spontaneous make-believe play or social imitative play appropriate to developmental level; and
3. restricted repetitive and stereotyped patterns of behavior, interests, and activities, as manifested by at least one of the following: (a) encompassing preoccupation with one or more stereotyped patterns of interest that is abnormal either in intensity or focus; (b) apparently inflexible adherence to specific, nonfunctional routines or rituals; (c) stereotyped and repetitive motor mannerisms (e.g., hand or finger flapping or twisting, or complex whole-body movements); or (d) persistent preoccupation with parts of objects.

An autistic disorder may also be characterized by delays or abnormal functioning in at least one of the following areas, with onset prior to age 3 years: (1) social interaction, (2) language as used in social communication, or (3) symbolic or imaginative play. Furthermore, an autistic disorder may be characterized by a disturbance that is not better accounted for by Rett's Disorder or Childhood Disintegrative Disorder.

2. Asperger's Syndrome

Asperger's syndrome may be characterized by qualitative impairment in social interaction, as manifested by at least two of the following:
1. marked impairment in the use of multiple nonverbal behaviors such as eye-to-eye gaze, facial expression, body postures, and gestures to regulate social interaction;
2. failure to develop peer relationships appropriate to developmental level;
3. a lack of spontaneous seeking to share enjoyment, interests, or achievements with other people (e.g., by a lack of showing, bringing, or pointing out objects of interest to other people); or
4. lack of social or emotional reciprocity.

Furthermore, Asperger's syndrome may be characterized by restricted repetitive and stereotyped patterns of behavior, interests, and activities, as manifested by at least one of the following:
1. encompassing preoccupation with one or more stereotyped and restricted patterns of interest that is abnormal either in intensity or focus;
2. apparently inflexible adherence to specific, non-functional routines or rituals;
3. stereotyped and repetitive motor mannerisms (e.g., hand or finger flapping or twisting, or complex whole-body movements); or
4. persistent preoccupation with parts of objects.

Asperger's syndrome may further be characterized by one of the following:
1. The disturbance causes clinically significant impairment in social, occupational, or other important areas of functioning.
2. There is no clinically significant general delay in language (e.g., single words used by age 2 years, communicative phrases used by age 3 years).
3. There is no clinically significant delay in cognitive development or in the development of age-appropriate self-help skills, adaptive behavior (other than in social interaction), and curiosity about the environment in childhood.
4. Criteria are not met for another specific Pervasive Developmental Disorder or Schizophrenia.

3. PDD-Not Otherwise Specified

This category may be used when there is a severe and pervasive impairment in the development of reciprocal social interaction or verbal and nonverbal communication skills. Alternatively, this category may be used when stereotyped behavior, interests, and activities are present, but the criteria are not met for a specific Pervasive Developmental Disorder, Schizophrenia, Schizotypal Personality Disorder, or Avoidant Personality Disorder. For example, this category includes atypical autism (e.g., presentations that do not meet the criteria for Autistic Disorder because of late age of onset, atypical symptomatology, subthreshold symptomatology, or a combination thereof).

4. Rett's Disorder

Rett's disorder may be characterized by: (A) all of the following:
1. apparently normal prenatal and perinatal development;
2. apparently normal psychomotor development through the first 5 months after birth; and
3. normal head circumference at birth; and

(B) Onset of all of the following after the period of normal development:
1. deceleration of head growth between ages 5 and 48 months;
2. loss of previously acquired purposeful hand skills between ages 5 and 30 months with the subsequent development of stereotyped hand movements (e.g., hand-wringing or hand washing);
3. loss of social engagement early in the course (although often social interaction develops later);
4. appearance of poorly coordinated gait or trunk movements; and
5. severely impaired expressive and receptive language development with severe psychomotor retardation.

5. Childhood Disintegrative Disorder (CDD)

Childhood disintegrative disorder may be characterized by:
(A) apparently normal development for at least the first 2 years after birth as manifested by the presence of age-appropriate verbal and nonverbal communication, social relationships, play, and adaptive behavior;
(B) clinically significant loss of previously acquired skills (before age 10 years) in at least two of the following areas: (1) expressive or receptive language; (2) social skills or adaptive behavior; (3) bowel or bladder control; (4) play; or (5) motor skills;
(C) abnormalities of functioning in at least two of the following areas:
   1. qualitative impairment in social interaction (e.g., impairment in nonverbal behaviors, failure to develop peer relationships, lack of social or emotional reciprocity);
   2. qualitative impairments in communication (e.g., delay or lack of spoken language, inability to initiate or sustain a conversation, stereotyped and repetitive use of language, lack of varied make-believe play); or
   3. restricted, repetitive, and stereotyped patterns of behavior, interests, and activities, including motor stereotypes and mannerisms; and
(D) the disturbance is not better accounted for by another specific Pervasive Developmental Disorder or by Schizophrenia.

C. The Integrated Model

Autism is a highly complex neurodevelopmental disorder affecting sensory and motor systems, speech and language acquisition, communication skills and social skills. Moreover, autistic children also typically have poor impulse control and idiosyncratic behaviors. Many of the available treatments are useful in treating certain aspects of this disorder. However, each child with an ASD presents a unique constellation of features and, not surprisingly, no one treatment method is equally effective in all autistic children or for all features of the disorder.

The present description contemplates an Integrated Model for the treatment of children afflicted with an ASD. As described further herein, the present model and methods provided herein pursuant to this model, provide a unique combination of multiple disciplines utilizing an array of the best available teaching techniques. Moreover, in particular embodiments, a close partnership with parents and families of the children having an ASD are developed. Also, the present methods may extend from the classroom of the child to their home and their community. Further, in particular embodiments, evaluation comprises an important and integral part of the present methods. The present methods improve on other models, in part, because therapeutic disciplines are isolated, and skills are worked on in isolation. Moreover, immediate generalization of skills worked on in isolation by demonstrating them with different people in different settings comprises another aspect of the present methods.

In one embodiment, the present methods combine aspects of ABA therapy, speech and language therapy, motor skills training, sensory integration therapy, and play and socialization With peers. Individual children, depending on their developmental level and symptoms, were often found to improve when subjected to different amounts of each of these approaches. The present methods integrates various child-appropriate elements from multiple approaches to produce natural and spontaneous behaviors and language in subjects with an ASD.

In one embodiment, the most appropriate treatment method is synthesized for each subject by thoroughly evaluating each subject's educational needs, and by synthesizing a curriculum which utilizes relevant techniques from all legitimate, well-studied methods. The resulting individualized methods maximize the prospects for reaching the subject's broadest and fullest developmental potential. In a particular embodiment, each subject's strengths and weaknesses are assessed to design an Individualized Education Plan (IEP) for each student. Also, this plan may be modified daily, if necessary, to help each subject reach his or her potential. The decision to alter or maintain a plan is made after retrieving individual information about the subject from an electronic database containing one or more measures of the subject's response to prior methods and exercises. Although not bound by theory, an indication of continual improvement in any one or more of various characteristics based on reference to data in the database indicates that present methods should be maintained.

ASD symptoms may comprise deficiencies in motor systems, speech and language acquisition, communication skills, social skills, focus and attention, eye contact, stress language development, and cognitive skills, or a combination thereof, among others known in the art and described herein (see, e.g., DSM-IV). On occasion, the reference to the database may reveal a leveling off in improvement or, less occasionally, a decrease in any one or more of various characteristics. In either of these later circumstances, the methods may be altered to address one or more specific characteristics to regain or attain continual improvement in the characteristic(s) or ASD symptoms.

The present methods comprise a multi-disciplinary team approach in which each discipline respects the merits of the other disciplines and works cooperatively to advance the subject's learning and behavioral control as indicated by one or more of the several characteristics discussed herein. In one embodiment, best practices from each field are integrated in a classroom setting. Moreover, in some embodiments, ABA therapy is utilized to enhance one or more characteristics such as focus and attention, eye contact, stress language development, and/or cognitive skills. Further, ABA trained therapists may work closely with speech/language trained therapists and occupational therapists to interface goals, techniques and consistency of each discipline. In another embodiment, the teaching of play skills also comprises an integral part of learning so that child-directed and optionally supervised play can be used to build relationships and encourage language and problem-solving.

In one embodiment, the present methods teach the children to socialize. Prior to the practice of the present methods, ASD children generally do not approach other children to appropriately interact and do not know how to respond to or initiate socialization. In one aspect, through the practice of the one on one model, children can have an adult shadow them and prompt them to talk to other children or look at what the other children are doing. A second adult, if present with the second child can prompt the response. For example, at snack-time a child might reach for another child's snack. The first instructor can prompt the child to ask his/her peer for some of the snack, and the second instructor could prompt the child with the snack to give some to the first child. It is through repetition and then generalization of these experiences with other children that socialization skills are built.

The subject's educational team may comprise instructors in multiple disciplines, including one or more ABA trained therapists, an instructor trained in speech therapy (i.e., a speech therapist) and an instructor trained in occupational therapy (i.e., an occupational therapist). The instructors from each discipline work with the subject individually, and also work together to generate appropriate programs and during group times. Speech therapists are also generally in the classroom for the entire day and advise the other therapists on appropriate modes and methods of communication. In one aspect, many of the children utilize augmentative communication methods such as the Picture Exchange Communication System (PECS) or sign language. Additionally, in another aspect, a speech therapist may be in the room to ensure that these communication methods are implemented correctly.

Although not bound by theory, ABA trained therapists are the behavioral experts and all instructors use behavioral techniques throughout their sessions to maximize performance and attention. In one aspect, an ABA grounded exercise (and ABA grounded therapy generally) stems from this collaboration. OTs spend time in the classroom and the lunchroom to advise on issues associated with self-regulation, motor control, and feeding. The team approach utilizes the expertise of each area, so that each instructor advises the others in their area of expertise. In one embodiment, team meetings are held for each room weekly to ensure that each child is discussed by the entire team together.

In another embodiment, ABA trained therapists specialize in behavioral control, attention, and cognitive skills, and their programs generally focus on learning those skills that children need to learn. Examples of these skills include but are not limited to imitation (of motor activities), visual spatial skills (increasing non-verbal problem solving, e.g., learning and finishing patterns, puzzles, sequencing, matching by category), acquisition of expressive and receptive vocabulary and concepts (in consultation with speech therapists, e.g., labeling items, receptively pointing to items, asking and answering “wh” questions), making requests, playing, following classroom routines, dressing, and/or eating. ABA therapy generally comprises breaking down tasks into small increments and teaching them step by step. In a particular aspect, an ABA grounded exercise stems from these practices when applied across multiple therapeutic disciplines discussed herein.

Speech therapists work on improving oral motor skills through various incrementally programmed tasks such as whistle blowing, massage, and different types of chewing, including PROMPT© (Prompts for Restructuring Oral Muscular Phonetic Targets) therapy. The PROMPT© therapy helps the child learn the muscular input involved in generating expressive language, communicating wants and needs, making requests, and generalizing the language that the children have learned in their ABA sessions. For example, if the child learned the action word “jumping” the speech therapist might use a different variety of people jumping to work on this word.

Occupational therapists (OTs) often work on the child's ability to self-regulate and keep themselves at a sufficient level of arousal to enable learning. The OTs consult with classroom instructors on sensory breaks, as well as gross and fine motor planning and control, and learning the physical tasks of childhood (e.g., eating, handwriting, riding a bicycle, scooter, getting a haircut, etc.).

In one embodiment, speech/language therapists maintain the child's focus and attention during 1:1 therapy sessions through behavioral techniques, e.g., ABA. Further, the speech/language therapists generalize the speech/language skills stressed in the ABA sessions (i.e., the primary interactions). Often a speech/language therapist works together with an occupational therapist to encourage language during sensory integration therapy. Depending on the status of the child (e.g., expressive or receptive), each of the multiple aspects of speech/language therapy (e.g., pragmatic skills, oral-motor therapy, PROMPT© therapy, sign language and PECS, etc.) can be used. In one embodiment, each subject receives one hour of speech/language therapy (1:1 student:therapist) each day.

The present methods target all aspects of language throughout the course of a child's development, with adjustments made for their developmental level. The focus of therapy shifts as the child gains expressive language and pragmatics often take on a larger focus, although they are worked on throughout. In the example where a child is having difficulty communicating, a method of communication is located and implemented, and the present methods further work to achieve full language and/or communication development.

In one embodiment, occupational therapists provide sensory integration (including, e.g., tactile, vestibular, and proprioceptive senses) as well as a focus on fine motor and graphomotor (including, e.g., visual-perceptual skills, orthographic coding, motor planning and execution, kinesthetic feedback and visual-motor coordination) skills. Often the occupational therapists interface with classroom therapists, for example, to plan a daily exercise routine, increase attention via movement and tactile techniques, and/or increase focus and verbalizations during class time.

Although not bound by theory, the present methods are generally guided by one or more of the following concepts: (1) no two children with autism or another ASD are alike; (2) parent involvement in the learning process and activities of their child is significant to the child's growth and development; and (3) skills developed at school should be reinforced outside of school and/or within the community, to aid in the generalization of behaviors (i.e., become part of daily living).

Although not bound by theory, several unique aspects of the present methods include but are not limited to: the assessment of receptive language, motor, imitation, planning and pre-academic skills; the development of a baseline of skills from which improvement is measured; the use of a computer system for centralized record keeping; an accessible system for keeping up to date information; the combination of disciplines (e.g., ABA type therapy, Developmental, Individual-Difference, Relationship-Based (DIDRB) type therapy, occupational therapy, speech and language therapy, music therapy); the use of a 4:3:1 student/instructor/speech & language therapist ratio in classroom setting; the practice of ABA-type therapy followed by group activities; and the in-school combined with at-home components.

The present methods further incorporate several unique goals and/or functional milestones. For example, one goal or functional milestone relates to improving behavioral control and attention, so that the child is ready to learn. Another goal or milestone relates to teaching the child to imitate, as children learn by imitating other children and children with autism do not naturally imitate others. Yet another involves increasing spontaneous language and socialization; and giving a child play and leisure skills, as many children with autism cannot structure their down time and engage in self-stimulatory behaviors when not actively engaged. Other goals or milestones include increasing communication and verbal skills (receptive, expressive language); improving overall motor tone and planning; improving non-verbal problem solving; and teaching abstract concepts. Children are taught structured exploration and play activities, and speech therapists utilize play time as an additional opportunity to link language development. While keeping a basic structure, the present methods allow a child to learn to explore toys appropriately, while preventing self-stimulatory and perseverative behaviors. As the children become more proficient in interacting with play materials, play time becomes less structured and more dictated by the individual child.

1. The Classroom Program

In one embodiment, 10 to 12 (up to 25, for example) children between 3 to 8 years old afflicted with an ASD are selected to take part in the program. Further, there is a ratio of one student to one instructor during instruction, and instructors may have a BA degree and a year of experience working with children on the autistic spectrum. The children are subjected to the present methods for a full day (e.g., from 8:45 am to 2:45 pm), each day (often comprising 5 days a week). Further, socialization (i.e., interaction with others besides a one on one interaction with an instructor) occurs on one or more occasions each day, e.g., during small group time, in the morning and/or in the afternoon. Each child is subjected to one on one therapy at multiple intervals throughout each day. In one aspect, as children develop more skills or mainstream characteristics, they will attend a less restrictive setting with one of their instructors to facilitate social interactions between them and their classmates. Moreover, after program activities are developed to provide additional socialization in activities with other children (e.g., Boy Scouts).

In another embodiment, the subject having an ASD is placed in a classroom setting, wherein multiple classrooms are provided in the school for practice of the present methods by four students and four instructors (including one speech and language trained therapist) in a classroom at a time. In one aspect, each classroom can be linked to an observation room having a one-way window for use by parents, instructors, therapists, and/or others. Further each classroom can be linked to a computerized database of child/ASD/program related information. In a further aspect, the school further includes a music therapy room, art therapy room, occupational therapy room, and lunchroom. Moreover, the school may also optionally further comprise a computer center to facilitate the daily data entry and information exchange to aid the on-going assessment process. The school may further incorporate multiple workstations, each linked to one another and to the computer system via a Local Area Network.

Persons trained in developmental pediatrics, ABA, special education, speech and language therapy, child psychology, occupational therapy (sensory integration, motor skills training and activities of daily living), or a combination thereof, may be instructors that are part of the present methods. As indicated herein, in a particular embodiment, each subject's curriculum is multidisciplinary and includes components of ABA therapy, speech and language therapy and OT/motor skills therapy.

As a component of ABA therapy, the therapist evaluates the specific behavioral features and interactive limitations of each individual child. These behavioral features or characteristics may be obtained via reference to a database of information developed and maintained in accordance with the present methods. These observations often form the basis of the treatment interventions for that child. During ABA therapy, complex tasks are broken into simple steps, with incremental teaching in a highly structured format with one instructor and one child. Moreover, the ABA trained therapist encourages a stepwise development of new, more appropriate behaviors through positive reinforcements each time she/he is able to elicit such behaviors. The process indicated herein maximizes the child's chances of success at each step, and therefore also maximizes the child's feelings of success and accomplishment. Although not bound by theory, one concept in ABA therapy relates to the shaping of complex social and linguistic behaviors using positive reinforcement of less complex, smaller subunits of behavior.

In a particular embodiment, play skills are taught to the ASD subject. It has been surprisingly recognized that play skills, together with ADA grounded therapy, are important components of each ASD student's progression. Child-directed play may be used to build relationships and encourage language use and problem solving.

In one embodiment, a multidisciplinary setting is provided for each ASD subject and each unique mode of instruction is fully integrated, and all instructors utilize principles of behavioral modification, regardless of their discipline (i.e., ABA grounded therapies or exercises). For example, staffing for a typical classroom of four students may be made up of three ABA therapists and a speech and language therapist.

2. The Home Program

One unique aspect of the present methods comprises continuing therapy after the school day ends. For example, additional ABA, speech/language or occupational therapy often continues after the subject leaves the classroom setting. This aspect occasionally further includes outside play, facilitated play dates or sports. This further aspect brings the subject into contact with typical peer role models, and aids in the generalization of behaviors learned in the classroom and structured embodiments. Moreover, often parent training takes place outside of the school setting and focuses, for example, on specific behaviors of the child, including behaviors that family members may find disruptive or difficult to manage. Such parent training/meetings may occur weekly. Also, instructors from the school may continue therapy outside of the classroom setting after school hours, or accompany the children to community activities. In one aspect, the after school activities provide, as much as possible, a seamless interface between the school, the home, and the community.

In a particular embodiment, one instructor, an ABA therapist (supervised by an educational supervisor) or an educational supervisor is assigned to each child to coordinate with the home therapists. Each subject involved in the present methods may receive therapy at home after leaving the classroom. On occasion, a home to program coordinator is provided (e.g., an instructor or educational supervisor) that spends about one to four, or about two hours/week working with the outside therapists to ensure that the present programming is represented and can be generalized to the home setting. OT's and speech therapists may communicate with the parents regarding feeding, communication, motor and/or sensory regulatory behaviors. Moreover, parents and relatives have an open invitation to visit the classroom, and they often arrange to participate in ABA, OT, or speech sessions for training.

3. Transition to Mainstream Schools

In one aspect of the present methods, as a child develops more skills he/she may spend up to half a day at a typical nursery school, accompanied by an instructor as an aid. Transitions of this type have been found to provide important exposure to typical peer role models in a school setting.

D. Results of the Practice of the Present Methods

The present methods have resulted in unexpectedly positive results in areas of expressive and receptive language, among many other areas. For example, over the course of nine months, out of each of the children subjected to the present methods, every student demonstrated improvement, and some incredibly so, in their language abilities. One of these children began the present methods with no language, and is now using spontaneous (unprompted) expressive language. Two children subject to the present methods have advanced to a point where they are able to have a mainstream school experience. In this circumstance, instructors of the present methods accompanied one child to a private pre-school for six hours a week and the second child for 15 hours a week. The latter of these children was unable to sit still in a chair or follow a single-step direction prior to the practice of the present methods. These represent some examples of surprising and unexpected results due to the practice of the present methods.

The present methods utilize trained instructors to aid the facilitation of interactions between a child and his peers/classmates and move control to the main instructor, increasingly fading him/herself as the process continues. Additionally, by having the instructor in the mainstream classroom, the instructor is able to bring back information on skills that the child needed to learn so that he/she could practice in a smaller environment.

Further examples include successful birthday party experiences, which none of the above children have had either as a guest or a celebrant, prior to practicing the present methods. The present methods enabled several of these children to enjoy celebrating their birthdays with a traditional party that included classmates, family and friends, for the first time in their lives.

Moreover, as a result of practicing the present methods, every student has made great progress in their self-help skills, including, for example, understanding why and how to wash themselves. Each of the children subjected to the present methods also mastered toilet-training and tricycle or bicycle riding.

The present methods may also be assessed using “nonobjective” evidence of success, such as increasing number of smiles, hugs and expressions of affection from children that previously were emotionally distant.

As indicated, the present methods have been surprisingly successful in a variety of ways. To further illustrate the effectiveness of the present, novel methods, the following descriptive evidence in the form of case histories is provided.

A. B. has autism with a poor prognosis. He had been asked to leave two special education schools, and his home therapists were refusing to work with him. No one had any success in reaching A. B. in his private world. At nearly four years old, he could not speak, did not make eye contact with others, and did not appear to have receptive language skills. During his first day in a program utilizing the present methods, A. B. spent several hours opening and closing doors and pressing the elevator button, and doing nothing else. He did not acknowledge his instructors and did not join in any group activities. After five months in the program, A. B. sits in his classroom and works with his speech and behavioral therapists. He is beginning to speak, and looks up and smiles when someone addresses him. He joins his classmates in the lunchroom. He is beginning to write his letters, something that his neuro-typical peers are doing, and he participates in games like “Musical Chairs” and “Simon Says” with his siblings. He is making progress every day within the program.

C. D. has autism, and spent his first three and a half years inside his family's apartment. Transitions and changes to his environment were unbearable for him. He would scream and cry when someone unexpected entered the room or when he was taken outside of his home. Once entering a program utilizing the present methods, trained therapists worked closely with C. D. His education plan called for sensory integration therapy and support in making transitions. After five months of attendance in the program, C. D. traveled on an outing with his father to Toys R Us, Times Square, and on the Ferris wheel, simple childhood pleasures C. D. 's parents never imagined they would be able to share with C. D. prior to C. D. 's participation in the program.

E. F. has autism with feeding issues, as many autistic children. When E. F. started school, he would eat only chocolate. He would not drink anything unless his mother handed it to him in a special cup, and so he refused all liquids during the school day. With the help of a team of behavior, speech and occupational therapists, E. F. has learned to try new foods. Within several months in the program, E. F. now has the will to taste almost anything provided for him, and more healthful foods are now a regular part of his diet.

While some of children subjected to the present methods provide successes that may seem like average milestones, they represent a tremendous amount of intervention for children with an ASD. The present methods practiced, full-time, five days a week, enabled these children to reach these milestones.

E. Objective Diagnostic Criteria/Measures

To gauge the progress of each subject taking part in the present methods, several diagnostic measures (and criteria) generally recognized in the art, including unique and important aspects of each measure evident to one skilled in the art, are utilized. For example, the Autism Diagnostic Observation Schedule (ADOS) (WPS, 1999) is utilized in the present methods involving assessment of a subject. The ADOS is a standardized, semi-structured assessment of communication, social interaction and play for individuals who may have autism or other pervasive developmental disorders. See, e.g., Lord, C. et al., J. Autism Dev. Disord. 19: 185-212 (1989). The ADOS comprises standardized activities that help the instructor observe the occurrence or non-occurrence of behaviors that have been identified as important to the diagnosis of autism and other pervasive developmental disorders across developmental levels and chronological ages. The ADOS provides data from direct observation of the subject's behavior. Structured activities and materials provide standard contexts in which social interactions, communication and other behaviors relevant to ASDs (or PDDs) are likely to appear. The ADOS comprises four modules, each of which is appropriate for children and adults of differing developmental and language levels, ranging from no expressive or receptive language to verbally fluent adults. These modules are labeled with numerals 1 to 4, with each activity numbered within its module.

Standardized cognitive measures for use in assessment of subjects having an ASD in the present methods include the Bayley Scales of Infant Development (BSID), Stanford-Binet Intelligence Scale (SBIS), and/or the Wechsler Preschool and Primary Scale of Intelligence (WPPSI). The BSID comprises three scales used to diagnose developmental delay and plan intervention strategies: mental scale and motor scale for assessment of the current level of cognitive, language, personal-social, fine and gross motor development. A Behavior Rating Scale assesses behavior during testing. The WPPSI (Wechsler, 1989) is an intelligence test for children from three to seven years of age. It represents a standard mode for assessment for many situations. In addition, use of the WPPSI during preschool years fits well with use of the Wechsler Intelligence Scale for Children as children enter school and require reassessment. The SBIS-IV is generally utilized for individuals aged two years to adult. It provides scores in four areas: Verbal Reasoning, Abstract and Visual Reasoning, Quantitative Reasoning, and Short-Term Memory; and a Composite Score that is equivalent to the Wechsler Scales Full Scale IQ. Standard scores with means of 100 and standard deviations of 16 are available for each of the four areas. The areas are composed of one or more subtests; the exact subtests administered depend on the individual's age and performance.

Standardized speech and communication measures for use in assessment of subjects having an ASD in the present methods include the Preschool Language Scale (4th ed.) (PLS-4) and the Receptive and Expressive One Word Vocabulary Tests (ROWPVT and EOWPVT, respectively). The PLS-4 (available from The Psychological Corporation, San Diego, Calif.) has two standardized subscales, Auditory Comprehension and Expressive Communication, which allow evaluation of a child's relative ability in receptive and expressive language. When comparing scores, one can determine whether deficiencies are primarily receptive or expressive in nature, or whether they reflect a delay or disorder in communication. Precursors of receptive skills (with a focus on attention abilities) and precursors to expressive skills (with a focus on social communication and vocal development) are also assessed.

Supplemental measures can include the Articulation Screener, the Language Sample Checklist, and the Family Information and Suggestions Form. The EOWPVT (available Academic Therapy Publications, Novato, Calif.) is an individually administered, norm-referenced test of a subject's ability to name objects, actions, and concepts pictured in illustrations. The subject's performance, when compared to the normative group, gives an indication of his or her English-speaking vocabulary. The ROWPVT (available from Academic Therapy Publications, Novato, Calif.) entails obtaining an estimate of a child's one-word hearing vocabulary based on what the child has learned from home and school. It provides information about the child's ability to understand language. This is a standardized test that provides age equivalents, standard scores, scaled scores, and percentile ranks.

Standardized occupational therapy measures for use in assessment of subjects having an ASD in the present methods include the Peabody Developmental Motor Scales (PDMS) for Gross and fine motor performance. The PDMS comprises an early childhood motor development program that provides both in-depth assessment and training or remediation of gross and fine motor skills.

The Assessment of Basic Language and Learning Skills (ABLLS) may be further utilized to assess curriculum development. The ABLSS focuses on the concept of the child as a speaker, and not merely a responder. The ABLSS incorporates spontaneous language and the natural environment into the structure of ABA, and enables tracking of the child's learning that is data-driven and individualized. The ABLSS curriculum also places a strong focus on motivating the child, teaching imitation, spontaneous language, flexibility in language use and play skills. (See, Sundberg and Partington, Teaching Language to Children with Autism or Other Development Disabilities, 1998).

Furthermore, the ABLLS is an assessment, curriculum guide, and skills tracking system for children with language delays. The ABLLS contains a task analysis of the many skills necessary to communicate successfully and to learn from everyday experiences. Thus, the ABLLS provides both parents and professionals with criterion-referenced information regarding a child's current skills, and provides a curriculum that can serve as a basis for the selection of educational objectives.

Other features and advantages of the invention will be apparent from the following detailed description, and from the claims.

The present invention is further described by the following examples. The examples are provided solely to illustrate the invention by reference to specific embodiments. These exemplifications, while illustrating certain specific aspects of the invention, do not portray the limitations or circumscribe the scope of the disclosed invention.

### EXAMPLES

### Example 1

Each child subjected to the present methods has been diagnosed with an ASD by a qualified medical professional. Copies of all medical, educational, and other records are kept on file at the school, and are considered as the child's Individualized Education Program is created. The present program has served 12 children from September 2002 through August 2003.

Upon entering the program, each new student takes part in a two-week evaluation period. Instructors develop a baseline of skills for the student to establish goals and measure progress. During this evaluation period, the child's expressive and receptive language, motor, imitation, planning, and pre-academic skill are evaluated and documented. Based on the child's relative strengths and weaknesses, a program is created with goals outlined on a daily basis. Every child's teaching program is evaluated daily for effectiveness. If the child is not responding to methods being used, based in part via reference to a database, the plan is modified until the desired outcome is achieved.

A database for centralized record keeping has been designed. All instructors have access to a child's electronic file, containing up to date information on the child's educational plan, progress, and communication between the educational team, the child's family, and the at-home therapists. Digital technology is used to record classroom activities, and store video and still files on the computer system for review by instructors and parents.

The program is year-round. The program year begins in early September and ends in late August, with a two-week break before the beginning of the next session. Children begin their day at the program at 8:45 a.m. and are dismissed at 2:45 p.m (see, e.g., Example 2). Each child spends the majority of his or her day in a classroom with three other children of comparable skills and abilities, and four professionals. The children spend an hour working one-on-one with a behavioral or speech and language specialist on objectives set out in their daily educational program. Each hour is followed by a 15-minute group activity, which contributes to the development of language and social skills. One hour a day is spent with one of the programs' occupational therapists to strengthen students' fine and gross motor and sensory integration abilities. Children generally receive music and art therapy once each week as a way of enhancing their overall program.

The program places a heavy emphasis on the teaching of play skills, which form an integral part of learning for the children. Child-directed play may be used to build relationships and encourage language use and problem solving. Pre-academic skills are further incorporated into a child's educational program as he or she becomes ready.

Moreover, as one component of the program, partnerships with mainstream schools are maintained to facilitate the transition to a mainstream classroom setting. Generally, children who are transitioning to a mainstream classroom are accompanied to the school by an instructor.

The present program also provides an after school, home-based therapy program component as an additional component of the present program, based on the recognition that children who receive at least some therapy at home make greater strides than those who are only treated in a clinic setting. This component is in many ways similar to the school-day program, with one-to-one therapy for the child using a variety of well-researched strategies. The goal of home therapy is to ease the child's transition from school to home, and to help him or her generalize skills developed in the classroom to every day activities. A number of families choose to use one of the school's instructors to execute their home program. Some have outside therapists working closely with instructors in the program, to see that objectives and progress are shared. The home program has the added benefit of involving parents, caregivers and siblings in the educational program.

The present program recognizes the importance of family participation in the recovery of children with an ASD. Parents come to the school about once a week to work with their child and a therapist in the classroom to acquire some of the tools used to help their children develop communication, social, and play skills. As mentioned above, family members and caregivers also play an active role in the home program.

The program holds parent-instructor conferences about three times a year to discuss student progress. Instructors are accessible to family members to discuss their concerns, answer questions, and make referrals. Parents are always welcome at the school; they can easily observe their children in the classroom without disruption via a one-way window.

### Example 2

Children are grouped into classes and classrooms of four children each. Each class has a 4:3:1 student/instructor/speech and language therapist ratio. Children transition repeatedly from small group activities to individualized teaching periods to small group activities. An example of a daily schedule is provided below:
8:45-9:00 am arrival and structured free play
9:00-9:15 exercise and sensory integration
9:15-10:15 1:1 programs ABA/OT/Speech and language
10:15-10:30 story, small group & snack
10:30-11:30 1:1 programs ABA/OT/Speech and language
11:30-12:00 pm 1:1 programs—play skills/playground
12:00-12:30 instructional lunch
12:30-1:30 1:1 programs ABA/OT/Speech and language
1:30-2:00 creative arts in small groups (art, music, movement)
2:00-2:45 1:1 programs ABA/OT/Speech and language

In addition, speech and language and occupational therapy are each provided daily for one hour for each child.

A further exemplary week schedule is set out below.

| | Monday | Tuesday | Wednesday | Thursday | Friday |
|---|---|---|---|---|---|
| 8:45-9:00 | Greeting | Greeting | Greeting | Greeting | Greeting |
| | and tabletop | and tabletop | and tabletop | and tabletop | and tabletop |
| | play | play | play | play | play |
| | Activ. sched. | | | | |
| 9:00-9:15 | 1:1 Sensory | Sensory | Sensory | Sensory | Sensory |
| | Circle | Circle | Circle | Circle | Circle |
| 9:15-10:15 | 1:1 | | | | |
| | 10 min | | | | |
| | manding | | | | |
| | followed by | | | | |
| | cold probe | | | | |
| 10:15-10:30 | Snack and | | | | |
| | group | | | | |
| | reading | | | | |
| 10:30-11:30 | 1:1 | 1:1 | 1:1. | 1:1 | 1:1 |
| | 10 min | | | | |
| | manding | | | | |
| | followed by | | | | |
| | cold probe | | | | |
| 11:30-12:00 | 1:1 | | 1:1 | | 1:1 |
| | 15 min | | 15 min | | 15 min |
| | Track | | track eye | | Track |
| | behaviors | | contact | | behaviors |
| 12:00-12:30 | Instructional | Instructional | Instructional | Instructional | Instructional |
| | Lunch | Lunch | Lunch | Lunch | Lunch |
| 12:30-1:30 | 1:1 | 1:1 | 1:1 | 1:1 | 1.1 |
| | 10 min | | | | |
| | manding | | | | |
| | followed by | | | | |
| | cold probe | | | | |
| 1:30-1:45 | 1:1 | | | | |
| | Small Group | | | | |
| | with toy | | | | |
| | play | | | | |
| 1:45-2:05 | 1:1 | | | | |
| | Visual | | | | |
| | schedule | | | | |
| 2:05-2:40 | 1:1 | 1:1 | 1:1 | 1:1 | 1:1 |
| 2:40-2:45 | Goodbye | Goodbye | Goodbye | Goodbye | Goodbye |
| | Circle | Circle | Circle | Circle | Circle |

The above schedule time includes art (2×/week), cooking, community outing, cleaning up, or activity schedule. Moreover, each individual session may begin with 10 minutes of mandatory training. Additionally, sessions of one hour should follow mandatory training with a cold probe of skills in acquisition. All mastered skills are displayed on a wall, drills are crossed off that upon completion, and skills are circled that require re-probing. If a child does not correctly answer mastered material on re-probe, this material is added to the acquisition sheet.

### Example 3

In another example, the child arrives at 8:45 and is greeted by their “special person,” comprising an instructor or speech therapist from their classroom who is assigned to the child for the year. This person periodically writes in a child communication book to document communication related progression information (including, on occasion, a daily note sent home to the parents) and conveys information to and from the parents at drop off and pick up.

The day starts with “circle time.” Prior to and during circle time, the classroom team (including ABA therapists, a speech therapist, and an occupational therapist) work together to create activities that are appropriate for the children (e.g., songs are selected by speech therapists with ABA therapists, and OTs work on the hand motions, etc.). Following circle time, the children have individual and small group sessions (see Example 2). Moreover, during the course of a day, a child is subjected to about 45 minutes to about 1 hour of individual occupational therapy and 1 hour of individual speech therapy. The children work on their structured individual educational programs during the one on one time. The programs are written for each discipline (e.g., ABA, OT, speech, etc.), but are worked on across disciplines. For example, OTs write programs for handwriting, cutting and fine motor activities that are carried out in the classroom by ABA therapists. Moreover, speech and OT therapists may work on increasing the number of textures a child can tolerate, as well as chewing gum, etc. In general, the discipline having expertise in a certain skill introduces that skill to the child, and then it is generalized across disciplines.

### Example 4

The program of Examples 1-3 may take place in a building having classrooms. For example, six classrooms are provided for use by four students and four instructors each. Each of these rooms is supplied with toys, games, educational materials, and furnishings. An occupational therapy room is further provided that is fully equipped with indoor sensory and play equipment, a music therapy room and some instruments, and an art therapy room with art materials. The program facilities further incorporate a computer center for instructors, to facilitate the daily data entry and information exchange that is crucial to our on-going assessment process. The computers are connected through a Local Area Network and have broadband Internet access.

### Example 5

A food program may be further provided for the program of Examples 1-4. Children with an ASD may have difficulties around food and eating as a result of their sensory issues, motor challenges, and behavioral rigidity. For example, two students were on a single food diet prior to entry into the present program. To aid students in overcoming this barrier to healthy eating and begin to enjoy mealtime, a program-wide plan was constructed that involved instructors, speech therapists, occupational therapists, and family members. Foods were introduced not just in a mealtime setting, but at different times throughout the day. Traditional ABA techniques together with generalized therapies were used to provide positive reinforcement. Moreover, occupational therapists worked with students on sensory issues. Instructors communicated methods used and progress made to caregivers and home therapists.

As a result, all our students are trying new foods and obtaining more nutrients through their diet. Meal times are less of a struggle and more of a pleasurable experience. Program instructors implemented similar programs to address issues around hair and nail cutting. Step by step, we have reduced anxiety and increased cooperation around these grooming rituals.

### Example 6

Example 6 provides the number of goals acquired on average in an ABLLS curriculum. The scores are particularly impressive considering that 56% of the sample do not yet have functional language and are still acquiring basic language skills.

### Number of Goals Acquired on Average in ABLLS Curriculum

| | |
|---|---|
| Cooperation and Reinforcer Effectiver | 2.53125 |
| Visual Performance | 10.25 |
| Receptive Language | 16.3125 |
| Imitation | 5.03125 |
| Vocal Imitation | 4.6875 |
| Requesting | 5.59375 |
| Labeling | 13.25 |
| Intraverbals | 16.25 |

The above examples are included for illustrative purposes only and are not intended to limit the scope of the invention. Many variations to those described above are possible. Since modifications and variations to the examples described above will be apparent to those of skill in this art, it is intended that this invention be limited only by the scope of the appended claims.

Citation of the above publications or documents is not intended as an admission that any of the foregoing is pertinent prior art, nor does it constitute any admission as to the contents or date of these publications or documents.

1. A method for ameliorating an autistic spectrum disorder (ASD), comprising:
a) subjecting a person diagnosed with an autistic spectrum disorder (ASD) to a primary interaction comprising an applied behavior analysis (ABA) exercise with an instructor in a one-to-one setting;
b) subjecting the person to a secondary interaction with a group comprising an additional person diagnosed with an ASD, an additional instructor one of which is a speech therapist; and
c) subjecting said person to occupational therapy.

2. The method of claim 1, wherein said ABA exercise is a ground exercise.

3. The method of claim 1, wherein said exercise is capable of improving deficiencies in communication, behavior, gross motor skills and sensory integration.

4. The method of claim 1, wherein said secondary interaction comprises generalizing said ABA exercise with said group.

5. The method of claim 1, wherein said instructor and additional instructor are trained in ABA.

6. The method of claim 1, wherein said group comprises four persons diagnosed with an ASD and four instructors, one of which is a speech therapist.

7. The method of claim 1, wherein said group comprises five persons diagnosed with an ASD and four instructors, one of which is a speech therapist.

8. The method of claim 1, wherein the ratio of person diagnosed with an ASD and instructor is 1:1.

9. The method of claim 1, wherein said ASD is an autistic disorder, Asperger's Syndrome, pervasive development disorder-Not Otherwise Specified (PDD-NOS), Rett's Disorder, Childhood Disintegrative Disorder (CDD), or a combination thereof.

10. The method of claim 1, further comprising assessing the level of functioning of said person diagnosed with ASD in an ASD symptom, and placing said person in a group with an additional person having a comparable level of functioning in said ASD symptom as said person.

11. The method of claim 1, further comprising assessing the level of cognition, speech, communication, and motor development in said person diagnosed with ASD.

12. The method of claim 1, wherein said ABA grounded exercise comprises behavioral control, attention, cognitive skills, imitation of motor activities, sensory integration training, visual spatial skills, speech and language training, playing, following classroom routines, dressing, eating, improving oral motor skills, self-regulation, gross and/or fine motor skills training, or a combination thereof.

13. The method of claim 12, wherein said speech and language training comprises comprising acquisition of expressive and receptive language skills.

14. The method of claim 1, wherein said primary interaction has a duration of about one hour.

15. The method of claim 1, wherein said secondary interaction has a duration of about 15 minutes.

16. The method of claim 1, further comprising a transition period between the primary and secondary interaction, said transition period having a duration of about five seconds to 5 minutes.

17. The method of claim 1, wherein each primary and secondary interaction is repeated sequentially about 2 to 5 times within a span of about 5 to 8 hours.

18. The method of claim 1, wherein the primary interaction comprises motor systems development, speech and language acquisition, communication skills, social skills, focus and attention, cognitive skills, or a combination thereof.

19. The method of claim 1, wherein the secondary interaction comprises a supervised group interaction therapy.

20. The method of claim 1, further comprising practicing said primary and secondary interaction in the home of said person diagnosed with ASD.

21. The method of claim 1, wherein the person is a child between the ages of 3 to 8 years old.

22. The method of claim 1, further comprising assessing said ASD symptom using Autism Diagnostic Observation Schedule, Bayley Scales of Infant Development, Stanford-Binet Intelligence Scale, Wechsler Preschool and Primary Scale of Intelligence, Preschool Language Scale, Receptive and Expressive One Word Vocabulary Tests, Peabody Developmental Motor Scales for Gross and fine motor performance, Assessment of Basic Language and Learning Skills, or a combination thereof.

23. The method of claim 1, wherein said person is further subjected to music therapy.
